(19) United States
(12) Patent Application Publication
(10) Pub. No.: US 2023/0102612 A1
(43) Pub. Date: Mar. 30, 2023

(54) ACCELERATING THE ACIDIFICATION SPEED OF LACTIC ACID BACTERIA

(71) Applicant: DSM IP ASSETS B.V., Heerlen (NL)

(72) Inventors: Monica Diana VLASIE, Echt (NL); Pieter Cornelis LANGEVELD, Echt (NL)

(21) Appl. No.: 17/906,112

(22) PCT Filed: Mar. 29, 2021
(86) PCT No.: PCT/EP2021/058139

§ 371 Date: Sep. 12, 2022

(30) Foreign Application Priority Data
Mar. 31, 2020 (EP) 20167159.1

(51) Int. Cl. A23C 11/10; A23L 11/50; A23L 11/65; A23J 3/16; A23J 3/34

(52) U.S. Cl. CPC A23C 11/106; A23L 11/50; A23L 11/65; A23J 3/16; A23J 3/346; A23V 2002/00; A23Y 2240/75; A23Y 2220/15

(57) ABSTRACT

The present invention describes a method for preparing a fermented food product comprising a plant protein, comprising
incubating a solution comprising a plant protein with phytase, and
fermenting a solution comprising a plant protein with lactic acid bacteria.

### FIELD

The present invention relates to a process for preparing a fermented food product comprising a plant protein. According to another aspect, the present invention relates to a fermented food product. According to yet another aspect, the present invention relates to the use of phytase for accelerating the acidification speed of lactic acid bacteria in a solution comprising a plant protein.

### BACKGROUND

In a world with a growing population there is an increased demand of proteins. To respond to this growing demand of proteins, there is a need to look at wider applications of proteins. In addition, it is desired to look for plant proteins as an alternative for animal proteins, since it is considered that plants are a more sustainable source of proteins than animals. The use of plant proteins in a fermented food product is limited in part because the acidification process for preparing, for example, yogurt alternatives from plant based ingredients takes longer than in the regular dairy yogurt process.

There is a need in the art to improve the production process of a plant protein comprising fermented food product. The present patent application addresses this need.

### SUMMARY

The invention provides:
method for preparing a fermented food product comprising a plant protein, comprising incubating a solution comprising a plant protein with phytase, and fermenting a solution comprising a plant protein with lactic acid bacteria;
a fermented food product obtainable by a method of the invention;
use of phytase for increasing the acidification speed of lactic acid bacteria in a solution comprising a plant protein.

### DETAILED DESCRIPTION

Surprisingly, phytase addition to a process for producing a fermented food product which comprises a plant protein increases the acidification speed during fermentation. This will lead to a shorter processing time and a significant decrease in the risk of contamination.

Acidification of plant based raw materials with microbial cultures takes a long time, thereby increasing the price of the production of plant yoghurt alternatives. In addition, long hours close to neutral pH conditions increase the risk of unwanted microbial growth.

It is surprising that phytase speeds up the culture acidification process.

Throughout the present specification and the accompanying claims, the words “comprise”, “include” and “having” and variations such as “comprises”, “comprising”, “includes” and “including” are to be interpreted inclusively. That is, these words are intended to convey the possible inclusion of other elements or integers not specifically recited, where the context allows.

The articles “a” and “an” are used herein to refer to one or to more than one (i.e. to one or at least one) of the grammatical object of the article. By way of example, “an element” may mean one element or more than one element.

In one of its aspect, the invention provides a method for preparing a fermented food product comprising a plant protein, comprising
incubating a solution comprising a plant protein with phytase, and
fermenting a solution comprising a plant protein with lactic acid bacteria.

Differently phrased, the invention provides a method for increasing the acidification speed of a solution comprising a plant protein, said method comprising
incubating a solution comprising a plant protein with phytase, and
fermenting a solution comprising a plant protein with lactic acid bacteria.

The phrases “food product comprising a plant protein” and “plant protein comprising food product” are used interchangeably herein and refer to a food product which comprises at least 10% (based on all proteins present) plant protein. Preferably, a food product comprising a plant protein comprises at least 20%, 30%, 40%, 50%, 60%, 70%, 80% or 90% (based on all proteins present) plant protein. Most preferably, a plant protein comprising food product comprises only (i.e. 100% based on all protein present) plant protein and no animal protein at all.

The phrase “fermented food product” refers to a food product which is obtained by the multiplication of microorganisms, for example lactic acid bacteria, in a solution comprising a plant protein (in case of lactic acid bacteria: leading to a protein coagulum). The particular characteristics of the various fermented food products depend upon various factors, such as the composition of solution comprising a plant protein, the incubation temperature, the lactic acid flora and/or non-lactic acid flora. Thus, a fermented food product comprising a plant protein manufactured herein include, for instance, various types of yoghurt, low fat yogurt, nonfat yoghurt, kefir, dahi, ymer, buttermilk, butterfat, sour cream and sour whipped cream as well as fresh cheeses such as quark and cottage cheese. Preferably, the fermented food product is a yogurt comprising a plant protein (i.e. a plant protein based yogurt) which can be used as a dairy yogurt alternative (plant protein based yogurt), i.e. a yogurt which does not or hardly not comprise any dairy or animal protein.

The phrases “solution comprising a plant protein” and “a plant protein comprising solution” are used interchangeably herein and refer to a liquid composition which comprises a plant protein. Such a liquid composition is for example prepared by dissolving (or diluting depending on the state of matter of the starting material) a plant flour or plant protein concentrate or a plant protein isolate into a suitable liquid (for example water or a buffered solution). The concentration of plant protein in the plant protein comprising solution will for example depend on the desired food product (for example, a low protein or a high protein drink) but also on the starting material. The skilled person is able to prepare a solution comprising a plant protein with a suitable amount of plant protein. The concentration of plant protein in the plant protein solution is at least 0.5% (w/w), preferably at least 1% (w/w), more preferably at least 1.5% (w/w) or 2% (w/w) and most preferred at least 2.5% (w/w).

Preferably, a method of the invention starts from a plant flour, a plant protein concentrate or a plant protein isolate. In case a flour, concentrate or isolate is not available, the skilled person can also start from plant grains, peas, beans, nuts or seeds and process them in a drink according to well-known methods which typically involve steps like (i) cleaning, soaking and/or dehulling, (ii) grinding of the starting material to produce a slurry, powder or emulsion, (iii) heating to inactivate endogenous enzymes, (iv) filtration to remove solids, (v) adding of water and optionally sugar, (vi) pasteurization, (vii) homogenization and/or (viii) packaging, labelling and/or storage.

The preparation of a plant protein comprising solution may comprise mild (such as to avoid protein degradation) heating for a certain time to ensure that the flour, protein concentrate or protein isolate is completely dissolved and a homogenous plant protein solution is obtained before the incubation with phytase takes place.

A method of the invention can thus comprise an additional step which comprises dissolving flour or powder (plant protein isolate or plant protein concentrate) to obtain a solution comprising a plant protein.

The “plant protein comprising solution” may be subjected to a heat treatment to reduce the amount of micro-organisms and to extend the shelf life of the final food product. Suitable heat treatments are pasteurization or ultra-high temperature (UHT) treatment.

The term “phytase” as used herein refers to an enzyme that is capable of breaking down phytic acid/phytate (inositol hexaphosphate), by hydrolyzing phytic acid/phytate so as to release at least one phosphate group from phytate.

Phytases are widespread in nature and have been found in bacteria, yeasts, fungi and plants and phytases from any of these may be used in the invention. The fungal enzyme phytase from Aspergillus niger has been commercialized for use in animal feed and may also be used in the present invention. The gene encoding the enzyme has been cloned and the phytase enzyme has been overexpressed in Aspergillus niger. This fungus is grown on industrial scale in large fermentors allowing for the production of the enzyme. The fungus secretes considerable amounts of phytase which can be separated from the biomass in a series of filtration and ultrafiltration steps. The resulting concentrated ultrafiltrate is subsequently formulated into a stable granulate or liquid which may be used in the present invention.

The step of “incubating a solution comprising a plant protein with phytase” is performed under conditions such that phytase is able to perform its enzymatic activity. The skilled person is aware that the conditions for incubation depend for example on the specific enzyme used, enzyme concentration, time, temperature, pH etc. In the present invention phytase is typically incorporated in an amount of at least 0.1 FTU per gram flour, isolate or concentrate; one FTU being the activity of phytase that generates 1 μmol of inorganic phosphorus per minute from an excess of sodium phytate at pH 5.5 and 370° C. A suitable methodology for determining phytase activity is described in M. Wyss et al.; Biophysical Characterisation of fungal phytases (myo-Inositol hexakisphosphate phosphohydroiase): Molecular size, glycosylation pattern, and engineering of proteolytic resistance. Appl. Envir. Micr., 65 (2), 359-366, 1999. Preferably, phytase is incorporated in an amount of at least 0.5, 1.0, 1.5 or 2.0 FTU per gram flour, isolate or concentrate

Preferably, the phytase is added to a solution comprising a plant protein before incubating a solution comprising a plant protein with phytase (to obtain a phytase-treated solution).

The step of “incubating a solution comprising a plant protein with phytase” results in a phytase treated solution. The phytase treated solution can be subjected to an enzyme (phytase) inactivation step, for example by heating the phytase treated solution to 90° C. and keeping at 90° C. for 15 minutes. The inactivation step can also be combined with a heat treatment step to reduce the amount of micro-organisms.

The preparation of a fermented food product comprise a step of adding lactic acid bacteria to ferment the solution comprising a plant protein such as to obtain a fermented food product. Suitable lactic acid bacteria are described below. The solution may be incubated with the phytase prior or during fermenting the solution with the lactic acid bacteria. I.e. the phytase is added to the solution comprising a plant protein and is subsequently incubated such as to obtain a phytase-treated solution and the lactic acid bacteria are added to said phytase-treated solution and are subsequently allowed to acidify the phytase-treated solution to obtained a fermented food product. Alternatively, the lactic acid bacteria and the phytase are added to the solution comprising a plant protein and is subsequently incubated such as to obtain a fermented food product.
As used herein, the term “plant protein” refers to any protein from plant origin. Preferably, the plant protein is a protein from grains, pseudocereals, legumes, nuts, seeds or other sources such as coconut, potato, canola or tiger nut.

Examples of suitable grains are barley, fonio, maize, millet, oat, rye, sorghum, teff, 30 triticale, spelt, rice or wheat.

Examples of suitable pseudograins are amaranth, buckwheat or quinoa.

Examples of suitable legumes are lupin, pea, chickpea, beans (preferably faba beans), peanut or soy Examples of suitable nuts are almond, brazil, cashew, hazelnut, macadamia, pecan, 35 pistachio or walnut.

Examples of suitable seeds are chia seed, flax seed, hemp seed, pumpkin seed, sesame seed or sunflower seed.

The plant protein may comprise a blend of proteins which is prepared by mixing two or more plant protein types, for example by mixing almond and coconut proteins or by mixing almond and cashew proteins. I.e. in one of the embodiments, the solution comprising a plant protein comprises plant proteins from at least 2 different types of plants.

As mentioned above, a method of the invention preferably starts from a plant flour, plant protein concentrate or plant protein isolate. The preferred starting material depends, amongst others, on the amount of proteins present in a particular plant flour, plant protein concentrate or plant protein isolate. For example, rice or oat flour typically has a low protein concentration and hence it is preferred to start from rice protein concentrate, rice protein isolate, oat protein concentrate or oat protein isolate.

As disclosed in the experimental part, phytase incubation has an effect on all kinds of different starting materials (i.e. like plant flour, plant protein concentrate or plant protein isolate) but surprisingly, the step of “incubating a solution comprising a plant protein with phytase” has the biggest impact (in respect of reduction of the required acidification time) when the plant protein is prepared from a plant protein isolate. In one of its embodiments, the invention provides a method for preparing a fermented food product comprising a plant protein, comprising
incubating a solution comprising a plant protein with phytase, and
fermenting a solution comprising a plant protein with lactic acid bacteria,
wherein said solution comprising a plant protein is prepared from a plant protein isolate.

Alternatively phrased, in one of its embodiments, the invention provides a method for preparing a fermented food product comprising a plant protein, comprising
incubating a solution comprising a plant protein with phytase, and
fermenting a solution comprising a plant protein with lactic acid bacteria,
wherein said solution comprising a plant protein is a solution comprising a plant protein isolate.

I.e. a method as described herein preferably comprises an additional step of preparing a solution comprising a plant protein from a plant protein isolate.

In one of its embodiments, the invention provides a method for preparing a fermented food product comprising a plant protein, comprising
incubating a solution comprising a plant protein with phytase, and
fermenting a solution comprising a plant protein with lactic acid bacteria,

wherein said plant protein is soy, pea, almond or oat.

The fermentation step is performed with lactic acid bacteria such as Streptococcus thermophilus and optionally Lactobacillus delbruekii subsp. bulgaricus, but also, optionally, other microorganisms such as Lactobacillus delbruekii subsp. lactis, Bifidobacterium animalis subsp. lactis, Lactococcus lactis, Lactobacillus acidophilus and Lactobacillus casei, or any microorganism derived therefrom. The lactic acid strains other than Streptococcus thermophilus and Lactobacillus delbruekii subsp. bulgaricus, are typically intended to give the finished product various properties, such as the property of promoting the equilibrium of the flora. The fermentation process increases the shelf-life of the product while enhancing and improving the digestibility of the food product. Many different types of fermented products can be found in the world today.

As used herein, the term “yogurt” refers to a fermented plant milk product produced by fermentation of plant milk by lactic acid bacteria, also known as “yogurt cultures”. The fermentation of the (added) sugars in the plant milk produces lactic acid which acts on the plant milk protein to give the yogurt its texture. The plant milk is for example obtained by lactic acid fermentation by means of specific thermophilic lactic acid bacteria only (i.e. Lactobacillus delbruekii subsp. bulgaricus and Streptococcus thermophilus) which are cultured simultaneously and are found to be living in the final product in an amount of at least 10 million CFU (colony-forming unit) per gram of the yogurt. Preferably, the plant yogurt is not heat-treated after fermentation. Plant yogurts may optionally contain other ingredients such as sugar or sweetening agents, one or more flavouring(s), cereals or nutritional substances, especially vitamins, minerals and fibers.

Yogurt encompasses set yogurt, stirred yogurt, drinking yogurt, Petit Suisse, heat treated yogurt and yogurt-like products. Preferably, the yogurt is a stirred yogurt or a drinking yogurt. More preferably, the yogurt is a stirred yogurt.

The term “starter culture composition” or “composition” (also referred to as “starter” or “starter culture”) as used herein in the experimental part refers to a composition comprising one or more lactic acid bacteria, which are responsible for the acidification of the plant milk base. Starter cultures compositions may be fresh (liquid), frozen or freeze-dried. Freeze dried cultures need to be regenerated before use. For the production of a fermented plant product, the starter cultures composition is usually added in an amount of at least 0.01%, preferably from 0.01 and 0.02% by weight of the total amount of plant milk base.

As used herein, the term “lactic acid bacteria” (LAB) or “lactic bacteria” refers to food-grade bacteria producing lactic acid as the major metabolic end-product of carbohydrate fermentation. These bacteria are related by their common metabolic and physiological characteristics and are usually Gram positive, low-GC, acid tolerant, non-sporulating, non-respiring, rod-shaped bacilli or cocci. During the fermentation stage, the consumption of lactose by these bacteria causes the formation of lactic acid, reduces the pH and leads to the formation of a protein coagulum. These bacteria are thus responsible for the acidification of plant milk and for the texture of the fermented plant milk product.

In one of its embodiments, the invention provides a method as described herein, wherein the lactic acid bacteria belong to a genus chosen from the group consisting of Streptococcus spp., Lactobacillus spp., Bifidobacterium spp., Lactococcus spp., Streptococcus salivarius thermophilus, Lactobacillus lactis, Bifidobacterium animalis, Lactococcus lactis, Lactobacillus casei, Lactobacillus plantarum, Lactobacillus helveticus, Lactobacillus acidophilus and Bifidobacterium breve.

Preferably, the used culture composition comprises Lactobacillus delbruekii subsp. bulgaricus and Streptococcus thermophilus.

In case a plant protein solution does not comprise sufficient levels of a carbon source, a sugar can be added for the cultures to grow. Suitable examples of a sugar are sucrose or glucose or lactose. Preferably, sucrose or glucose is added. Alternatively, a method as described herein may comprise an additional step in which sugars (i.e. a carbon source) are produced in situ by incubating the starting material with an enzyme which is capable of producing a suitable carbon source. An example of such an enzyme is amyloglucosidase (glucoamylase).

The step of “fermenting a solution comprising a plant protein with lactic acid bacteria” is continued until the desired pH is reached. The desired pH depends on the fermented product and is well-known to the skilled person. In one of its aspects, the invention provides a method for preparing a fermented food product comprising a plant protein, comprising
incubating a solution comprising a plant protein with phytase, and
fermenting a solution comprising a plant protein with lactic acid bacteria,
wherein incubating the solution with phytase and fermenting the solution with lactic acid bacteria results in a reduction of the time to reach a pH below 5, preferably in the range of pH 4 to 5 or pH 4.4-4.8, of at least 10% when compared to a solution incubated with lactic acid bacteria only. Preferably, the time to reach a pH below 5, preferably in the range of pH 4 to 5 or pH 4.4-4.8, is at least 15%, 20%, 25%, 30%, 35%, 40%, 45% or 50% shorter when compared to a solution incubated with lactic acid bacteria only.

The aim of a method of the invention is “increasing the acidification speed of a solution comprising a plant protein”. Whether or not the acidification speed is increased can easily be determined by comparing a method of the invention with a similar method in which phytase is not used but all other conditions are identical. The acidification speed is typically expressed in hours or minutes.

In one of its embodiments, the invention provides a method for preparing a fermented food product comprising a plant protein, comprising
incubating a solution comprising a plant protein with phytase, and
fermenting a solution comprising a plant protein with lactic acid bacteria,
further comprising stopping said fermenting step at least 30 minutes earlier when compared to a(n otherwise identical) method which does not comprise an incubation with phytase. More preferably, the fermentation step is stopped at least 40, 50 or 60 minutes earlier when compared to a method which does not comprise an incubation with phytase. In case the solution comprising a plant protein is prepared from a protein isolate, a method as described herein comprises an additional step of stopping the fermentation step at least 1 hour earlier when compared to a method which does not comprise an incubation with phytase. Preferably, a method as described herein comprises an additional step of stopping the fermentation step at least 2, 3, 4, 5, 6 or 7 hours earlier when compared to a method which does not comprise an incubation with phytase. Preferably, the fermentation step is stopped when the pH is below 5, preferably in the range of pH 4 to 5 or pH 4.4 to 4.8. The fermentation step can for example be stopped by a cooling step.

The fermented food product in a method as disclosed herein is preferably yogurt.

Methods as described above may comprise an optional processing step. Examples of an additional processing step are homogenizing (for example used in the preparation of a stirred yogurt) or emulsification.

A method of the invention may also comprise a step of adding an ingredient, such as
adding of a micronutrient such as a vitamin or a mineral (for example calcium),
adding of (reduced amounts of) a stabilizer or a hydrocolloid,
adding of oil,
adding of (reduced amounts of) flavour components,
adding of a fruit preparation,
adding of a sugar such as sucrose or glucose,
adding of an enzyme which is capable of producing a suitable carbon source, or
adding of a cereal.

A method of the invention can further comprise a step of packaging the fermented food product in a suitable container.

The use of enzymes in the preparation of a food product comprising a plant protein is known. As a non-limiting example, reference is made to the production of oat milk which is similar to that of most other plant drinks. The process typically start with milling of oat grains to break the outer hull, then the grains are stirred in warm water and ground into a slurry. The slurry is treated with enzymes and heated to create a thick liquid oat base which can be further processed into the final oat drink or fermented oat product. Enzymatic hydrolysis of starch by alpha- and/or beta-amylase, producing maltodextrins (liquefaction) and subsequent hydrolysis of the dextrins to glucose by amyloglucosidase (gluco-amylase) (saccharification) or hydrolysis by alpha-amylase of dextrins to maltose (saccharification as well) are well known. Thus in one of its aspects, a method of the method further comprises incubating the solution comprising a plant protein with at least one starch degrading enzyme. In one aspect, said solution is first incubated with at least one starch degrading enzyme and subsequently with phytase. In yet another aspect, said solution is simultaneously incubated with at least one starch degrading enzyme and phytase. Examples of a suitable starch degrading enzyme are alpha-amylase, beta-amylase or gluco-amylase. Preferably, a method of the invention further comprises incubating the solution comprising a plant protein with at least two (preferably alpha-amylase and glucoamylase) or three starch degrading enzymes. Alpha-amylase, beta-amylase or gluco-amylase are commercially available and can thus be used by the skilled person in a method of the invention. Preferably, a method of the invention further comprises incubating the solution comprising a plant protein with at least two (preferably alpha-amylase and glucoamylase) or three starch degrading enzymes, such that liquefaction and saccharification can be performed in one step.

In yet another aspect, the invention provides a fermented food product obtainable by a method of the invention, i.e. by a method for preparing a fermented food product comprising a plant protein, comprising
incubating a solution comprising a plant protein with phytase, and
fermenting a solution comprising a plant protein with lactic acid bacteria.

Preferably, the food product is a dairy alternative food product. The terms “dairy alternative food product” and “non-dairy food product” and “dairy free food product” or “plant based food product” are used interchangeably herein and refer to a food product which does not comprise any dairy product.

In one of its aspect, the fermented food product is yogurt. Other examples of fermented food products are described above and apply to this part of the invention as well. A food product of the invention can be distinguished from prior art food products in view of the phytate content.

In a further aspect the invention provides use of phytase for increasing the acidification speed of lactic acid bacteria in a solution comprising a plant protein. In one of its embodiments, the invention provides use of phytase for increasing the acidification speed of lactic acid bacteria in a solution comprising a plant protein, wherein said solution comprising a plant protein is prepared from a plant protein isolate. In another embodiment, the invention provides use of phytase for increasing the acidification speed of lactic acid bacteria in a solution comprising a plant protein, wherein said plant protein is soy, pea, almond or oat, The definitions and explanations which are given above for the method claims apply to the use claims as well.

The invention will be explained in more detail in the following example, which are not limiting the invention.

### Experimental Part

The Production of Plant-Derived Beverages (Fermented and Non-Fermented) Processed with Phytase

Dairy alternatives (beverage and yoghurt) were produced from pea, soy and almond protein ingredients. The pea isolate, Pisane M9 was obtained from Cosucra, the soy isolate, Profam 974 was obtained from Archer Daniels company and the almond flour was purchased from notenshop.nl. The three different raw materials (pea isolate, soy isolate and almond flour) were processed into beverage by dissolving the powders in tap water with 2% w/w sucrose added, high speed mixing for 10 min at 40° C. followed by a heat step of 30 min at 85° C.

For the oat beverages, 10% and 15% flour solutions were made in water followed by the addition of a starch hydrolysing enzyme, amyloglucosidase in order to release glucose (between 1-3% glucose generated). No additional sucrose was added to the oat bases before the phytase incubation.

For the soy and pea beverage, a 4 w % protein solution in tap water was processed, assuming isolates with 94 and 86% protein, respectively, as indicated in specification sheets. For the almond beverage, a 10% dry weight solution was selected as suitable for processing, resulting in about 2.1 w % protein in the beverage. Processing was performed in the Thermomixer (TM5).

Phytase (DSM) was added in doses of 6 and 20 FTU/gram isolate/flour in the beverage. The beverage was left for incubation at 4° C. for 17 hours. For phytase inactivation, the beverage was heated up to 90° C. and held at 90° C. for 15 min after which it was cooled on ice.

A portion of these beverage alternatives obtained from the process described above was further analysed for enzyme conversion, texture and taste. The rest of the product was further processed into a yoghurt like plant alternative.

The 12 different plant-based beverages (4 raw materials with 2 or 3 different phytase incubations from previous step) were acidified at 42° C. with culture DelvoFresh YS-141. A 2 U bag YS-141 was dissolved in saline and from there added to the beverage, dosing 1.8 U/1000 kg. For each beverage one CINAC (˜80 ml) and three cups (˜125 ml) were used. CINAC acidifications were performed in a water bath set at 42° C., acidification in cups was performed in a stove set at 43° C. After reaching pH 4.6 or lower, fermentation was stopped, and samples were kept at 4° C.

### Example 1

Acidification Curves Plant Beverages Pre-Treated with Phytase

The 12 different plant-based beverages (4 raw materials with 2 or 3 different phytase incubations from previous step) were acidified at 42° C. with culture DelvoFresh YS-141 (this culture comprises Streptococcus thermophilus and Lactobacillus bulgaricus). A 2 U bag YS-141 was dissolved in saline and from there added to the beverage, dosing 1.8 U/1000 kg. For each beverage one CINAC (˜80 ml) and three cups (˜125 ml) were used. CINAC acidifications were performed in a waterbath set at 42° C., acidification in cups was performed in a stove set at 43° C. After reaching pH 4.6 or lower, fermentation was stopped, and samples were kept at 4° C.

TABLE 1
acidification time for plant beverage fermentation
Time to reach pH 4.6 (h)

| Condition | | | | Oat | Oat |
|---|---|---|---|---|---|
| (phytase | Soy | Almond | Pea | (10% | (15% |
| enzyme dose) | isolate | flour | isolate | flour) | flour) |
| No enzyme | 20.5 | 6.1 | 19.4 | 5.1 | 4.8 |
| 6 FTU/g DW | 7.4 | 5.0 | 12.2 | — | — |
| 20 FTU/g DW | 7.0 | 4.7 | — | — | — |
| 50 FTU/g starch | | | | 3.9 | 4 |

Significant increase in the acidification speed (>10% lower acidification time) was observed for all beverages in which phytase preincubation was done. For the beverages obtained from protein isolates, a significant longer acidification was observed with or without the enzyme addition than for the beverages obtained using flours as raw materials.

1. A method for preparing a fermented food product comprising a plant protein, comprising
incubating a solution comprising a plant protein with phytase, and
fermenting a solution comprising a plant protein with lactic acid bacteria.

2. The method according to claim 1, wherein the solution is incubated with the phytase prior or during fermenting the solution with the lactic acid bacteria.

3. The method according to claim 1 wherein said solution comprising a plant protein is prepared from a plant protein isolate.

4. The method according to claim 1, wherein said plant protein is soy, pea, almond or oat.

5. The method according to claim 1, wherein the lactic acid bacteria belong to a genus chosen from the group consisting of Streptococcus spp., Lactobacillus spp., Bifidobacterium spp., Lactococcus spp., Streptococcus salivarius thermophilus, Lactobacillus lactis, Bifidobacterium animalis, Lactococcus lactis, Lactobacillus casei, Lactobacillus plantarum, Lactobacillus helveticus, Lactobacillus acidophilus and Bifidobacterium breve.

6. The method according to claim 1, wherein incubating the solution with phytase and fermenting the solution with lactic acid bacteria results in a reduction of time to reach a pH below 5, optionally in a range of pH 4.4-4.8, which is at least 10% when compared to a solution incubated with lactic acid bacteria only.

7. The method according to claim 1, further comprising stopping said fermenting at least 30 minutes earlier when compared to a method which does not comprise an incubation with phytase.

8. The method according to claim 1, wherein the fermented food product is yogurt.

9. The method according to claim 1, further comprising incubating the solution comprising a plant protein with at least one starch degrading enzyme.

10. The method according to claim 9, wherein said solution is simultaneously incubated with at least one starch degrading enzyme and phytase.

11. A fermented food product obtainable by a method according to claim 1.

12. A product comprising phytase for increasing the acidification speed of lactic acid bacteria in a solution comprising a plant protein.

13. The product according to claim 12, wherein said solution comprising a plant protein is prepared from a plant protein isolate.

14. The product according to claim 12, wherein said plant protein is soy, pea, almond or oat.
